(19) United States
(12) Patent Application Publication
(10) Pub. No.: US 2026/0300162 A1
(43) Pub. Date: Oct. 1, 2026

(54) STORAGE SYSTEM AND STORAGE CONTROL METHOD FOR STORAGE SYSTEM

(71) Applicant: Hitachi Vantara, Ltd., Yokohama-shi (JP)

(72) Inventors: Naoya OKADA, Tokyo (JP); Yoshinori OHIRA, Tokyo (JP); Taisuke ONO, Tokyo (JP)

(73) Assignee: Hitachi Vantara, Ltd., Yokohama-shi (JP)

(21) Appl. No.: 19/325,009

(22) Filed: Sep. 10, 2025

(30) Foreign Application Priority Data
Mar. 27, 2025 (JP) 2025-053522

(51) Int. Cl. G06F 12/02

(52) U.S. Cl. CPC G06F 12/0246; G06F 2212/1016

(57) ABSTRACT

In a write process involving multiple storage nodes, each node contains a data storage area based on non-volatile storage devices. When updated data forming a stripe is written, two or more pieces of the data are distributed across different storage nodes. One node is responsible for assigning a sequence number to each piece of data. This sequence number, updated according to the writing state, serves as a reference for the order and status of the write operation. If power is unexpectedly lost and later restored, the storage node uses these sequence numbers to identify which data was being updated when the failure occurred. By comparing the sequence numbers of the different pieces of the stripe, the system can specify the correct update target. It then determines whether recovery should rely on the most recent updated data or revert to the previous non-updated version, thereby ensuring data accuracy and consistency after recovery.

### BACKGROUND OF THE INVENTION

### 1. Field of the Invention

The present invention generally relates to storage control of a storage system.

### 2. Description of Related Art

In related art, a redundant configuration has been adopted in a storage system in order to improve availability and reliability. For example, PTL 1 discloses a storage system that manages storage controllers on a plurality of storage nodes as a redundancy group. When one storage controller receives a write request, data is transferred to another storage controller belonging to the same redundancy group, and each storage controller stores the data in a storage device of its own storage node.

### CITATION LIST

### Patent Literature

PTL 1: WO2018/179073

### SUMMARY OF THE INVENTION

As a storage system, there is a storage system that associates a plurality of logical areas constituting a volume with a plurality of physical areas of a storage device, and in response to a write request to a virtual volume, updates data of a physical area corresponding to a write destination virtual area in the virtual volume. In such a storage system, when power is lost while updating data on the storage device, an error may occur in the data of the physical area during data updating (typically, the data is corrupted and does not match any of non-updated data and updated data).

According to PTL 1 described above, when updating data on a storage device, the storage system performs updating after leaving updated data as a log in the storage device in advance, so that even when an error occurs in data in a physical area as an update target, the error can be resolved by applying the updated data written earlier as the log. Meanwhile, in this storage system, in response to a write request, in order to update data on the storage device, the updated data is written twice to the storage device (the updated data is written as the log and written to the physical area as an update target), and a required time or a required calculation amount required for processing the write request increases, and write performance may deteriorate.

The invention is made in view of the above problems, and an object of the invention is to reduce the number of times of writing to a non-volatile storage device and improve write performance while preventing a decrease in reliability of data.

In write processing in which, among a plurality of storage nodes each having a data storage area based on a storage area of a non-volatile storage device, two or more pieces of updated data forming a stripe are written to two or more data storage areas of two or more different storage nodes, one storage node assigns a sequence number which is a number associated with each of the two or more pieces of data and updated according to a state related to writing of the data to the data storage area. The two or more pieces of updated data include one or more pieces of user data which are one or more pieces of data constituting data related to a write request, and one or more pieces of redundant data of the one or more pieces of data. When power is lost and power is turned on again in relation to the two or more storage nodes, at least one storage node of the two or more storage nodes specifies data as an update target when the power is lost from the two or more pieces of data based on a sequence number of each of the two or more pieces of data of the stripe, and determines which of non-updated data and updated data is a recovery target for the data as an update target.

According to the invention, it is possible to reduce the number of times of writing to a non-volatile storage device and improve write performance while preventing a decrease in reliability of data.

### BRIEF DESCRIPTION OF THE DRAWINGS

FIG. 1 is a diagram illustrating a configuration example of an entire system including a storage system according to an embodiment;

FIG. 2 is a diagram illustrating an example of a hardware structure of a storage node;

FIG. 3 is a diagram illustrating an example of a software configuration of the storage system;

FIG. 4 is a diagram illustrating an example of a logical configuration of the storage system;

FIG. 5 is a diagram illustrating a configuration example of a memory of the storage node;

FIG. 6 is a diagram illustrating an example of a data layout;

FIG. 7A is a diagram illustrating an example of a data storage format;

FIG. 7B is a diagram illustrating another example of the data storage format;

FIG. 8 is a diagram illustrating an example of a node management table;

FIG. 9 is a diagram illustrating an example of a mapping table;

FIG. 10A is a diagram illustrating an example of a node state management table;

FIG. 10B is a diagram illustrating an example of an I/O in-progress management table;

FIG. 11 is a flowchart of write processing;

FIG. 12 is a flowchart illustrating details of a portion of the write processing;

FIG. 13 is a sequence diagram of in-order write;

FIG. 14 is a flowchart of processing between storage nodes in sequence number embedding write processing;

FIG. 15 is a flowchart of power interruption recovery processing;

FIG. 16 illustrates a list of write states in the sequence number embedding write processing;

FIG. 17 is a list of correspondence relationships between the write states and recovery details;

FIG. 18 is a flowchart of recovery data determination processing (S1514 in FIG. 15);

FIG. 19A is a flowchart of rebuild processing (S1515 in FIG. 15);

FIG. 19B is a schematic diagram of the rebuild processing; and

FIG. 20 is a flowchart of processing between the storage nodes in the sequence number embedding write processing.

### DESCRIPTION OF EMBODIMENTS

In the following description, an “interface device” may be one or more communication interface devices. The one or more communication interface devices may be one or more communication interface devices of the same type (for example, one or more network interface cards (NICs)) or two or more communication interface devices of different types (for example, NIC and host bus adapter (HBA)).

In the following description, a “memory” is one or more memory devices serving as an example of one or more storage devices and may be typically a main storage device. At least one memory device in the memory may be a volatile memory device or a non-volatile memory device.

In the following description, a “non-volatile storage device” may be one or more non-volatile storage devices. The non-volatile storage device may be a non-volatile memory device. The non-volatile storage device is, specifically, for example, a hard disk drive (HDD), a solid state drive (SSD), a non-volatile memory express (NVME) drive, or a storage class memory (SCM).

In the following description, a “processor” may be one or more processor devices. The at least one processor device may be typically a microprocessor device such as a central processing unit (CPU), and may be another type of processor device such as a graphics processing unit (GPU). The at least one processor device may be a single core or a multi-core. The at least one processor device may be a processor core. The at least one processor device may be a broadly defined processor device such as a hardware circuit (for example, a field-programmable gate array (FPGA), a complex programmable logic device (CPLD), or an application specific integrated circuit (ASIC)) that performs a part or all the processing.

In the following description, information that can be output in response to an input may be described by an expression such as “xxx table”, whereas the information may be data of any structure (for example, may be structured data or unstructured data), and may be a training model such as a neural network, a genetic algorithm, or a random forest that generates an output in response to an input. Therefore, the “xxx table” can be referred to as “xxx information”. In the following description, a configuration of each table is an example. One table may be divided into two or more tables, or all or some of two or more tables may be one table.

In the following description, processing may be described using a “program” as a subject, but since a program is executed by a processor to perform determined processing using a storage device and/or an interface device as appropriate, the subject of the processing may be a processor (or a device or a system including the processor). The program may be installed on a device such as a computer from a program source. The program source may be, for example, a program distribution server or a computer-readable recording medium (for example, a non-transitory recording medium). In the following description, two or more programs may be implemented as one program, or one program may be implemented as two or more programs.

A “volume” (VOL) is a logical storage area. The volume may be a substantive volume (RVOL) or a virtual volume (VVOL). The “RVOL” may be a VOL based on a storage device, and the “VVOL” may be a volume according to capacity virtualization technology (typically, thin provisioning).

Any information (for example, at least one of “name” and “number”) may be adopted as information (ID) for identifying an element.

In the following description, when elements of the same type are described without being distinguished, a common reference numeral may be used, and when elements of the same type are distinguished and described, reference numerals may be used.

In the following description, a redundant configuration group can be formed by a plurality of storage nodes. Examples of redundant configuration include erasure coding, redundant array of independent nodes (RAIN), mirroring between nodes, and redundant array of independent (or inexpensive) disks (RAID) in which a node is regarded as one drive, and any of them may be used. The “redundant configuration group” may be a group that includes two or more storage areas provided by two or more storage nodes and stores redundant data. A definition of each of the plurality of types of storage areas in the following description may be as follows. For example, a “redundant configuration area” may be a logical storage area provided by the redundant configuration group. A “node area” may be a logical storage area provided by each of the plurality of storage nodes. A plurality of node areas respectively provided by a plurality of storage nodes may constitute a redundant configuration area. A “strip” may be a part of the node area. The strip stores data/parity (user data or parity). A strip in which data is stored can be called a “user strip”, and a strip in which parity is stored can be called a “parity strip”. The “user data” is a part of a user data group as at least a part of data (write target data) according to a write request. The “user data group” is a set of all user data stored in a stripe. The “parity” is data generated based on the user data group. The user data or parity is stored in each strip forming a stripe. The “stripe” may be a storage area including two or more strips (for example, two or more strips having the same logical address) present in two or more node areas in the redundant configuration area. The user data and the parity created based on the user data are stored in the same stripe.

Hereinafter, one embodiment will be described.

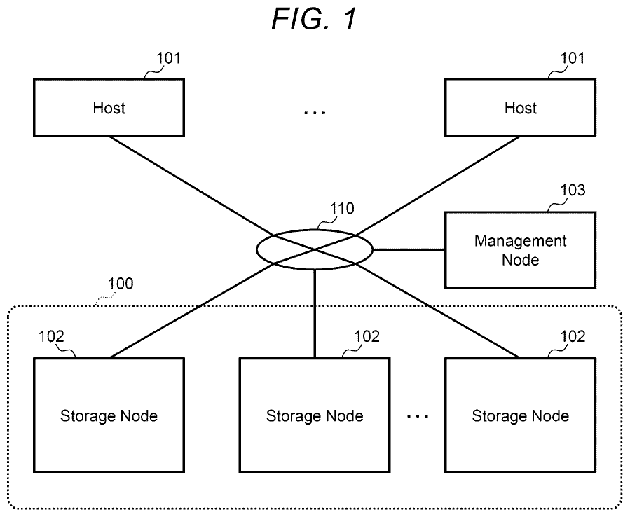

FIG. 1 is a diagram illustrating a configuration example of an entire system including a storage system according to the embodiment.

A storage system 100 is communicably connected to a plurality of (or one) hosts 101 and a management node 103 via a network 110. The storage system 100 includes a plurality of storage nodes 102. The storage system 100 may include the management node 103. The network 110 may be any network such as the Internet, Ethernet (registered trademark), a wide area network (WAN), a local area network (LAN), or a fibre channel (FC) network.

The host 101 may be an example of an input/output (I/O) source that is a source of an I/O request. The host 101 may be a physical or virtual computer device. The host 101 transmits an I/O request (write request or read request) to the storage node 102 in response to a request from an application program or the like operating on the host 101. The I/O source may exist in the storage system 100 (for example, in at least one storage node 102). The I/O source may be an application.

The storage node 102 is a computer device that provides the host 101 with a VOL as a storage area for reading and writing data. The storage node 102 is, for example, a general-purpose computer device.

The management node 103 is a physical or virtual computer device that is used by a system administrator to manage the entire storage system 100. The management node 103 manages the plurality of storage nodes 102 as a group called a cluster. FIG. 1 illustrates an example in which only one cluster is provided, but a plurality of clusters may be provided in the storage system 100.

Thus, the storage system 100 includes one or more storage nodes 102. A configuration in the drawing is an example, and the host 101, the storage node 102, and the management node 103 may be the same node. The storage system 100 may be implemented by a virtual machine or a container, or may be configured to coexist as processes in one computer device. The network 110 may be redundant, or may include a management network used for communication for management and a storage network used for data I/O to the storage node 102. The storage system 100 may be a system as software-defined anything (SDx) constructed by each of one or more physical computer devices executing predetermined software. For example, software-defined storage (SDS) or software-defined datacenter (SDDC) can be adopted as SDx.

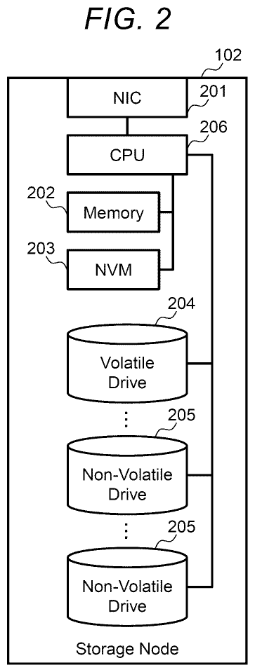

FIG. 2 is a diagram illustrating an example of a hardware structure of the storage node 102.

The storage node 102 includes a network interface card (NIC) 201, a central processing unit (CPU) 206, a memory 202, a non-volatile memory (NVM) 203, one or more volatile drives 204, and one or more non-volatile drives 205.

The NIC 201 is an example of an interface device and performs communication via the network 110. The NIC 201 receives an I/O request from the host 101.

The memory 202 is typically a volatile memory device. The memory 202 and the NVM203 are examples of a memory.

Each of the drives 204 and 205 is an example of a storage device. The non-volatile drive 205 is, for example, a solid state drive (SSD). The one or more non-volatile drives 205 are an example of the non-volatile storage device.

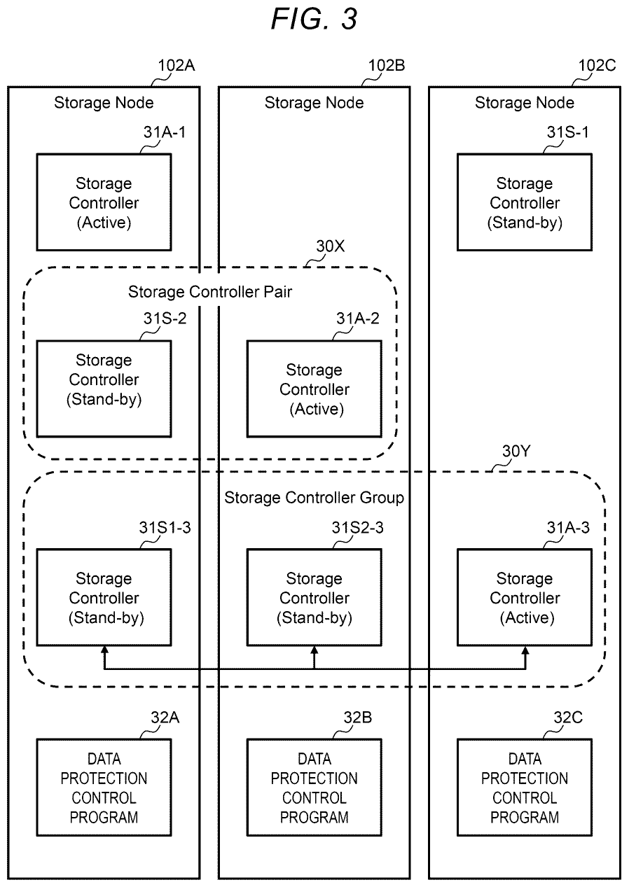

FIG. 3 is a diagram illustrating an example of a software configuration of the storage system.

The storage system 100 includes, for example, storage nodes 102A to 102C. Each storage node 102 includes a data protection control program 32 and one or more storage controllers 31.

The storage controller 31 is a storage control program and performs data I/O in response to an I/O request. The storage controller 31 is, for example, a program that functions as a controller for the SDS. The storage controller 31 issues an I/O command corresponding to the I/O request from the host 101 to the data protection control program 32. The storage controller 31 has a VOL configuration function. The VOL configuration function associates logical chunks implemented by the data protection control program 32 with logical volumes provided to the host. An association method may be, for example, a straight mapping method (a method in which a logical chunk and a VOL are associated on a 1:1 basis and addresses of the logical chunk and the VOL are the same) or a VVOL method (a method in which a VOL and a logical chunk are divided into small-sized areas (pages) and addresses of the VOL and the logical chunk are associated with each other in units of pages).

In the embodiment, a storage controller cluster 30 is adopted in which a storage controller 31 implemented in a storage node 102 forms a redundant configuration together with another storage controllers 31 arranged in another storage node 102. The storage controller cluster 30 includes two or more different storage controllers 31 in two or more different storage nodes 102. The storage controller cluster 30 includes one active controller 31A and one or more stand-by controllers 31S. The active controller 31A is the storage controller 31 in a state where the storage controller 31 can receive an I/O request (active state). The stand-by controller 31S is the storage controller 31 in a state where the storage controller 31 does not receive an I/O request (stand-by state). The storage node 102 on which the active controller 31A operates may be referred to as an “active node 102”, and the storage node 102 on which the stand-by controller 31S operates may be referred to as a “stand-by node 102”. Which storage nodes 102 are active nodes may differ depending on the storage controller cluster 30. The storage controller cluster 30 implemented by one active controller 31A and one stand-by controller 31S can be referred to as a “storage controller pair 30X”, and the storage controller cluster 30 implemented by one active controller 31A and two or more stand-by controllers 31S can be referred to as a “storage controller group 30Y”.

An area made up of one or more stripes may be associated with each storage controller cluster 30. The area may be an area (for example, a physical page) that can be associated with VVOL 410V. The stripe may be associated with any one of the storage controller clusters 30.

In the storage controller cluster 30, when a power loss occurs in the active controller 31A or the storage node 102 in which the active controller 31A is arranged, a state of the stand-by controller 31S is switched to the active state, and as a result, the stand-by controller 31S becomes the active controller 31A. I/O processing executed by the active controller before switching can be taken over by the active controller 31A after switching. In other words, in each storage controller cluster 30, when a power loss or the like of the active node occurs, failover from the active controller 31A to any one of the stand-by controllers 31S is performed.

The data protection control program 32 allocates a physical storage area provided by the drive 205 in its own storage node 102 or another storage node 102 to each storage controller cluster 30 as a logical chunk. Further, for designated data, the data protection control program 32 reads or writes the data from or to the corresponding drive 205 in accordance with the above-described I/O command given from the storage controller 31. There are, for example, two methods for allocating a physical storage area for the data protection control program 32, either of which is applicable to the storage system 100. A first method is a method of allocating a physical area of one storage device to one logical chunk. That is, this is a method of allocating a physical area of one drive 205 in its own storage node 102 or in the other storage node 102 to each storage controller cluster 30. The second method is a method in which, in order to provide data redundancy among a plurality of storage nodes 102, physical areas of the drives 205 in two or more storage nodes 102 are allocated to one logical chunk.

When a physical storage area provided by the drive 205 in the other storage node 102 is allocated to the storage controller cluster 30, the data protection control program 32 executes the following processing. That is, the data protection control program 32 cooperates with another data protection control programs 32 implemented in the other storage node 102, and exchanges data with the other data protection control programs 32 via the network 110. Accordingly, the data protection control program 32 follows the I/O command from the active controller 31A of the storage controller cluster 30 and reads or writes data related to the I/O command from or to a storage area in the other storage node 102.

When the data protection control program 32 adopts a redundant method as a physical storage area allocation configuration, corresponding methods for storing data in two or more drives 205 include the mirroring method and erasure coding (EC) method. Any method is applicable to the storage system 100.

In the mirroring method, the data protection control program 32 writes data provided by the active controller 31A of the storage controller cluster 30 to the drives 205 on two or more corresponding storage nodes 102 to make the data redundant.

In the EC method, the data protection control program 32 divides the data provided by the active controller 31A of the storage controller cluster 30 into first data and second data. The first data is stored in a first storage node 102, the second data is stored in a second storage node 102, and parity calculated based on the first data and the second data is stored in the drive 205 of a third storage node 102.

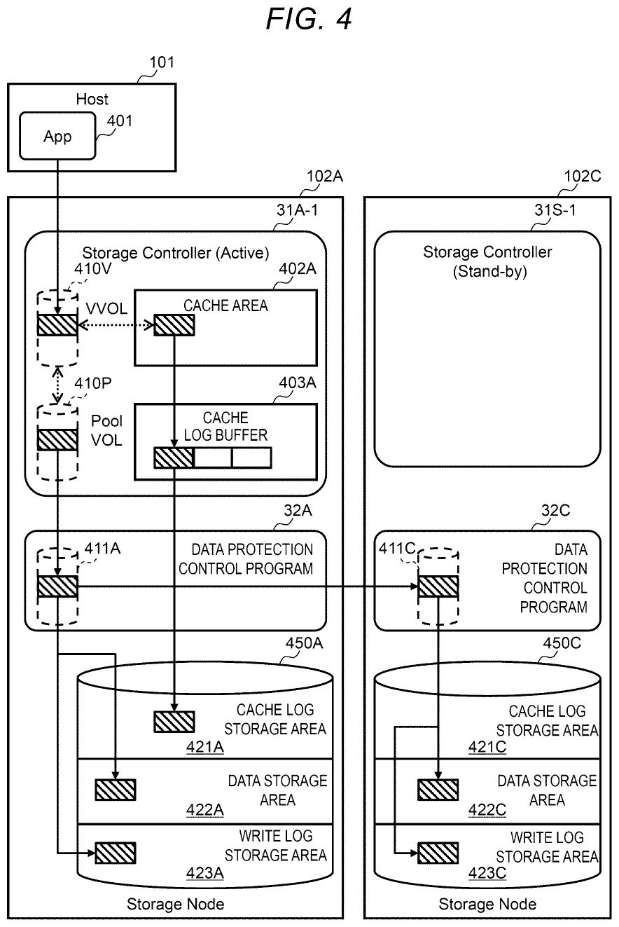

FIG. 4 is a diagram illustrating an example of a logical configuration of the storage system 100. The storage nodes 102A and 102C are taken as an example.

Each storage node 102 includes a storage area 450 based on one or more non-volatile drives 205. The storage area 450 includes a cache log storage area 421, a data storage area 422, and a write log storage area 423.

The cache log storage area 421 is a write-once (log-structured) area where data written to the cache area 402 is added as a cache log. That is, when updated data is written in a certain area in the cache area 402, non-updated data in the certain area is overwritten with the updated data, but in the cache log storage area 421, the cache log as the updated data is added to the cache log as the non-updated data without being overwritten.

Data written in the virtual storage area (VVOL 410V) provided to the host 101 is written in the data storage area 422. The data is written in the data storage area 422. Specifically, when the updated data is written to a certain area (for example, a virtual page) in the VVOL 410V, the updated data is added to an area (for example, a physical page) corresponding to the certain area in the data storage area 422. At this time, a physical address corresponding to a logical address of the data is changed from a physical address of the non-updated data to a physical address where the updated data is to be added.

The write log storage area 423 is a write-once (log-structured) area where data written in the VVOL 410V is added as a write log.

For each of the cache log storage area 421, the data storage area 422, and the write log storage area 423, information indicating a range of the drive and an address indicated by the area may be in, for example, a drive management table to be described later.

An active controller 31A-1 provides the host 101 with the VVOL 410V in which an area is mapped according to writing from a storage area (pool VOL 410P) provided by the data protection control program 32A (thin provisioning method). The active controller 31A-1 secures a cache area 402A and a cache log buffer 403A on the memory.

The data protection control program 32A provides the pool VOL 410P based on the storage area 450, and manages an area 411A corresponding to the pool VOL 410P. The area 411A corresponding to the pool VOL 410P corresponds to the data storage area 422. For example, the data protection control program 32A creates the pool VOL 410P associated with the data storage area 422 in the storage nodes 102A and 102C by the so-called mirroring method, and provides the pool VOL 410P to the active controller 31A-1. The storage node 102C is the storage node 102 having a stand-by controller 31S-1 in the storage controller cluster including the active controller 31A-1.

The active controller 31A-1 may receive a write request designating an area in the VVOL 410V from the host 101 and select either a write-through operation or a write-back operation.

When the write-back operation is selected, the active controller 31A-1 writes data and a guarantee code (to be described later) to the cache area 402A, and adds an update content including the data and the guarantee code to the cache log buffer 403A as a cache log. When a certain amount of cache logs are accumulated in the cache log buffer 403A, the active controller 31A-1 adds the certain amount of cache logs to the cache log storage area 421A.

After writing the cache log or when selecting the write-through operation, the active controller 31A-1 passes the write request to the data protection control program 32A. When the data protection control program 32A receives the write request from the active controller 31A-1, the data protection control program 32A transmits the write request to a data protection control program 32C of the other storage node 102C having the drive 205 as a data redundant write destination.

Next, the data protection control programs 32A and 32C determine whether to write a write log to the write log storage area 423. When the write-through operation is selected by the active controller 31A-1, the data protection control programs 32A and 32C determine to write the write log. Then, the data protection control programs 32A and 32C add the data and the guarantee code to the write log storage area 423 as the write log. After writing the write log, the data protection control programs 32A and 32C write the data and the guarantee code to the data storage area 422.

Meanwhile, when the write-back operation is selected by the active controller 31A-1, the data protection control programs 32A and 32C determine not to write the write log, and write the data and the guarantee code to the data storage area 422 as they are.

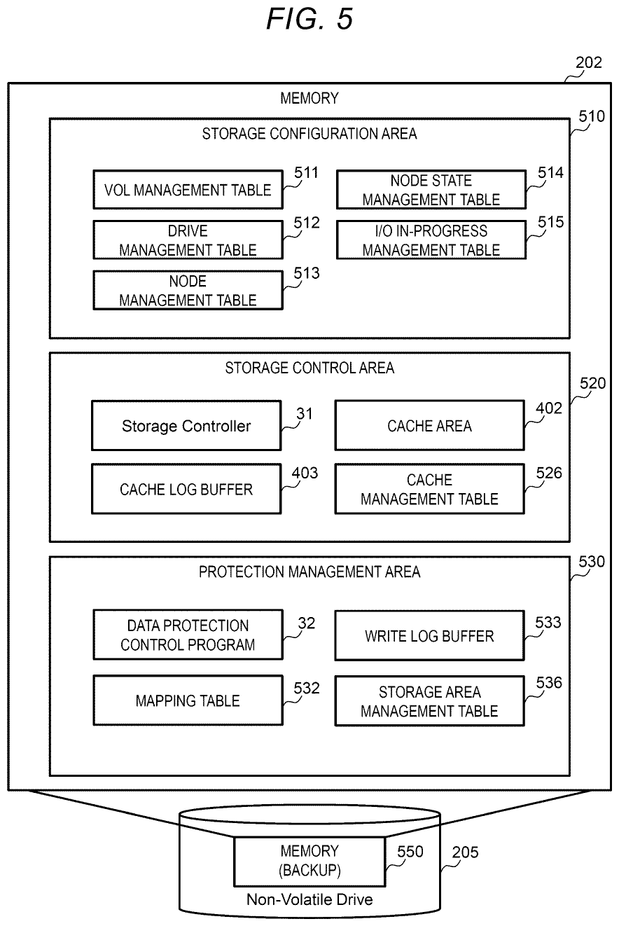

FIG. 5 is a diagram illustrating a configuration example of the memory 202 of the storage node 102.

The memory 202 includes a storage configuration area 510, a storage control area 520, and a protection management area 530. Programs and data in these areas 510, 520, and 530 may be backed up as backup data 550 in the non-volatile drive 205 in the storage node 102. A program in the memory 202 is executed by the CPU 206.

The storage configuration area 510 stores a VOL management table 511, a drive management table 512, a node management table 513, a node state management table 514, and an I/O in-progress management table 515. The VOL management table 511 has information related to VOLs such as the VVOL 410V and the pool VOL 410P (for example, information representing VOL ID, type, and a capacity for each VOL). The VOL management table 511 may include information indicating mapping between a virtual page in the VVOL and a physical page in the pool VOL 401P for each VVOL 410V. The drive management table 512 includes information related to the non-volatile drive 205 (for example, information indicating a drive ID and a capacity for each drive 205). The tables 513 to 515 will be described later. At least a part of these tables 511 to 515 may be shared (for example, synchronized) among all the storage nodes 102 belonging to the cluster 30 for each storage controller cluster 30.

The storage controller 31 and a cache management table 526 are stored in the storage control area 520. The storage control area 520 includes the cache area 402 and the cache log buffer 403. The cache management table 526 includes information on cache (for example, information on addresses of the cache area 402, the cache log buffer 403, and the cache log storage area 421, and information on a storage destination address of the cache log). The storage controller 31 has all functions other than functions of the data protection control program 32. Among the functions of the storage controller 31, some functions other than the functions of the data protection control program 32 may be provided in a program independent of the storage controller 31. The storage controller 31 may include the data protection control program 32.

The protection management area 530 stores the data protection control program 32, a mapping table 532, and a storage area management table 536. The protection management area 530 includes a write log buffer 533 used as a buffer for a write log. The storage area management table 536 includes information on the data storage area 422 and the write log storage area 423 (for example, information on addresses of the areas 422 and 423).

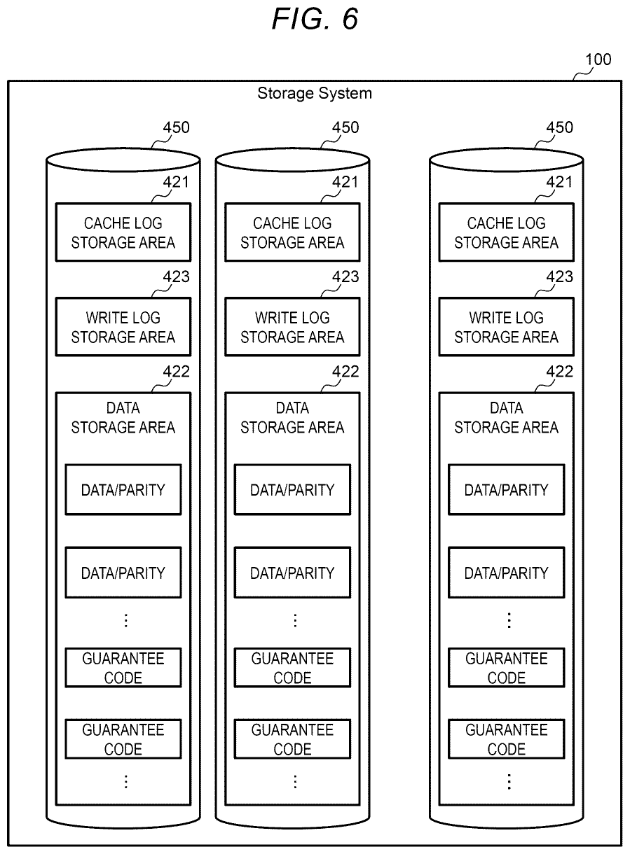

FIG. 6 is a diagram illustrating an example of a data layout.

The storage system 100 has a plurality of storage areas 450 described with reference to FIG. 4. One storage node 102 has at least one storage area 450. Each storage area 450 includes the cache log storage area 421, the data storage area 422, and the write log storage area 423. Data/parity (user data or parity) and a guarantee code for each piece of data/parity are stored in the data storage area 422.

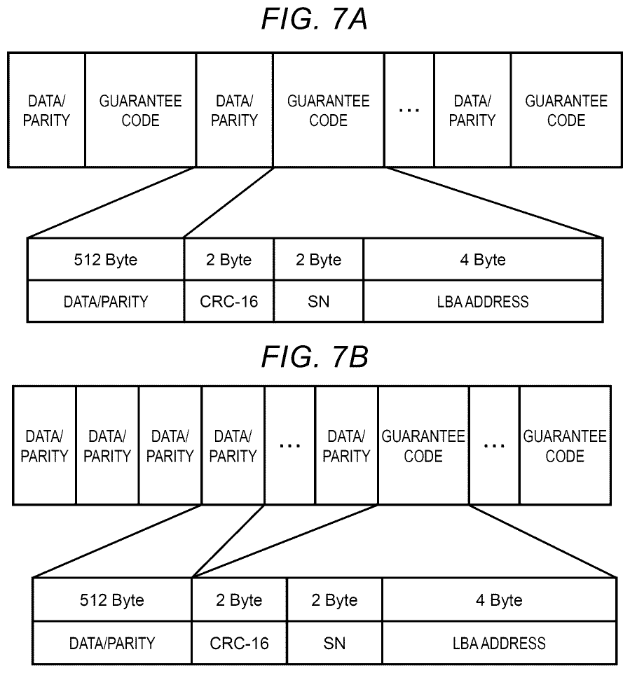

FIG. 7A is a diagram illustrating an example of a data storage format.

According to this drawing, a set of 512 Byte data/parity and an 8 Byte guarantee code of the data/parity (that is, 520 Byte data) is stored in the data storage area 422 (drive 205). Sizes of the data/parity and the guarantee code are examples.

The “guarantee code” is a code used for verifying consistency of the data/parity, and may be called, for example, a data integrity field (DIF) code, and may be a checksum, a cyclic redundancy code, or the like as a specific example. The guarantee code includes an error detection code (for example, a CRC code) and metadata. The metadata may include data representing a sequence number (denoted as “SN” in the drawing) in the embodiment in addition to an address (for example, an LBA address) of data/parity. The “sequence number” is used to specify whether the data/parity in the drive 205 is before or after the update. In the embodiment, a value of the sequence number is either “0” which means before the update, or “1” which means after the update. As the value of the sequence number, in addition to these values, for example, a value (for example, “2”) indicating that updating is in progress may be adopted, or the value of the sequence number is incremented, and thus the value indicating that the data/parity is after the update may be a value larger than the value indicating that the data/parity is before the update (for example, a value larger by 1 than the value indicating that the data/parity is before the update). The value that can be adopted as the sequence number and updating of the value of the sequence number may not be limited. The sequence numbers are assigned to the user data and the parity in the stripe, and the sequence numbers of the data (the user data and the parity) are the same number at the time of the assignment.

FIG. 7B is a diagram illustrating another example of the data storage format.

According to this drawing, the data storage area 422 (drive 205) is divided into a data/parity area and a guarantee code area. Only data/parity is stored in a continuous area as the data/parity area, and only a guarantee code is stored in a continuous area as the guarantee code area.

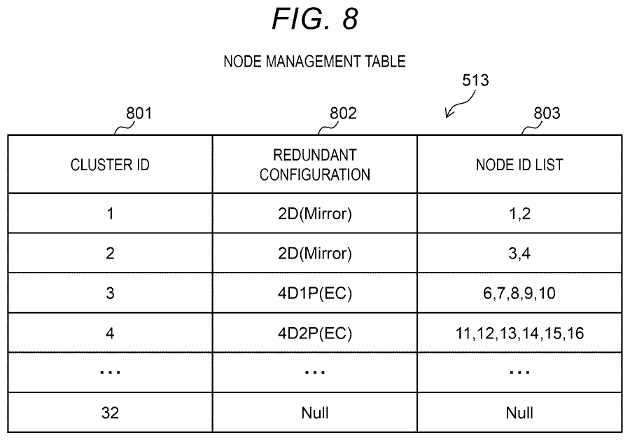

FIG. 8 is a diagram illustrating an example of the node management table 513.

The node management table 513 includes information on the storage node 102. The node management table 513 includes, for example, an entry for each storage controller cluster 30. The entry includes information such as a cluster ID 801, a redundant configuration 802, and a node ID list 803.

The cluster ID 801 represents an ID of the storage controller cluster 30. The redundant configuration 802 represents details of a redundant configuration in the storage controller cluster 30. The node ID list 803 represents an ID of each of the plurality of storage nodes 102 having a plurality of storage controllers 31 constituting the storage controller cluster 30. Hereinafter, the storage controller cluster 30 having an ID “p” is referred to as a “cluster “p””. The storage node 102 having an ID “q” is referred to as a “storage node “q””.

According to a cluster “1”, since the redundant configuration 802 is “2D(Mirror)”, user data is duplicated and stored in storage nodes “1” and “2” for each stripe. According to a cluster “3”, since the redundant configuration 802 is “4D1P(EC)”, four pieces of user data and one piece of parity are stored in storage nodes “6” to “10” for each stripe. According to a cluster “4”, since the redundant configuration 802 is “4D2P(EC)”, four pieces of user data and two pieces of parity are stored in storage nodes “11” to “16” for each stripe.

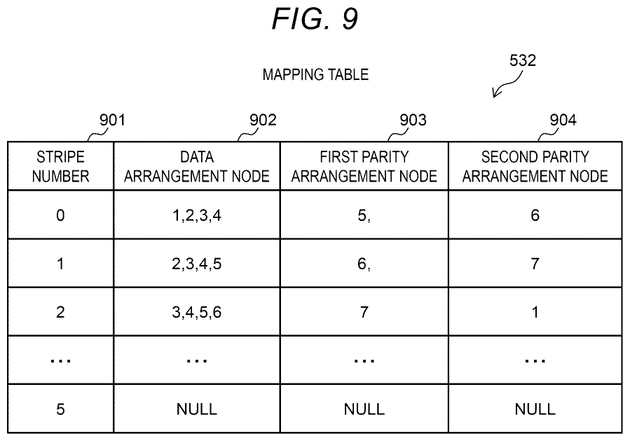

FIG. 9 is a diagram illustrating an example of the mapping table 532.

The mapping table 532 may exist for each storage controller cluster 30. The mapping table 532 represents arrangement of data/parity for each stripe. A configuration of the mapping table 532 may depend on a redundant configuration corresponding to the storage controller cluster 30. The mapping table 532 illustrated in FIG. 9 corresponds to 4D2P(EC).

For example, the mapping table 532 has an entry for each stripe. The entry includes information such as a stripe number 901, a data arrangement node 902, a first parity arrangement node 903, and a second parity arrangement node 904.

The stripe number 901 represents the number of a stripe. For example, the stripe number may be x% k(m+n). “x” is an access destination LBA. “%” is a modulo operator. “k” is the number of storage nodes 102 constituting the storage controller cluster 30 (“6” in the example illustrated in FIG. 9). “m” is m in mDnP and is the number of user data in one stripe (“4” in the example illustrated in FIG. 9). “n” is n in mDnP and is redundancy (“2” in the example illustrated in FIG. 9). The “redundancy” is a maximum number of storage nodes 102 that may be lost due to a power loss or the like while allowing data I/O to continue.

The data arrangement node 902 is a list of IDs of the storage nodes 102 in which user data is stored. The first parity arrangement node 903 represents an ID of the storage node 102 in which first parity is stored. The second parity arrangement node 904 represents an ID of the storage node 102 in which second parity is stored.

For the data storage area 422, information indicating a relationship between a stripe and a strip in an arrangement node, and an address of the strip may be in the drive management table 512, for example.

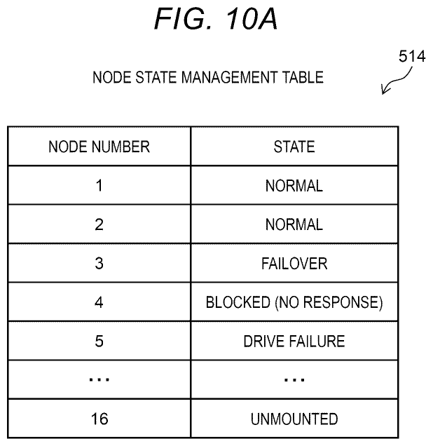

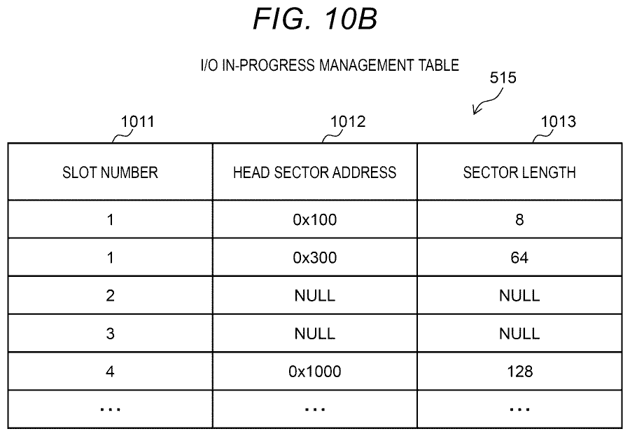

FIG. 10A is a diagram illustrating an example of the node state management table 514.

The node state management table 514 represents a node state of the storage node 102. The node states may include “normal”, “unmounted”, and states other than “normal” and “unmounted”, such as “failover”, “blocked (no response)”, and “drive failure”.

FIG. 10B is a diagram illustrating an example of the I/O in-progress management table 515.

The I/O in-progress management table 515 is a table used to determine whether data is made non-volatile (for example, data or a log is stored in any non-volatile area). For example, the active controller 31A makes write target data non-volatile before write processing is completed. After recovery from power interruption, when there is an incomplete I/O (a sector or a slot in an unwritten state), the active controller 31A performs subsequent I/O processing. The I/O in-progress management table 515 may exist for each storage controller cluster 30. For each storage controller cluster 30, all the storage nodes 102 related to the cluster 30 hold the I/O in-progress management table 515 corresponding to the storage controller cluster 30.

For example, the I/O in-progress management table 515 has an entry for each I/O. The entry has information such as a slot number 1011, a head sector address 1012, and a sector length 1013.

The slot number 1011 represents the number of a slot in I/O in-progress. The “slot” represents each of a plurality of fragmented areas that make up the storage area 450 (particularly, the data storage area 422). The slot includes a plurality of sectors. The sector may be an example of the smallest I/O unit of data. An area including a plurality of sectors may be provided to the data protection control program 32 as a physical storage area. The data protection control program 32 may allocate the provided physical storage area to a write destination physical page, and in response to a request from the storage controller 31, write data to the area allocated to the physical page.

The head sector address 1012 represents an address of a head sector of the I/O in progress. The sector length 1013 represents a sector length (for example, the number of sectors) occupied by I/O target data. A product of a sector size and the sector length may be a size of the I/O target data in progress. For example, one sector may be 512 Bytes.

According to the I/O in-progress management table 515, whether an I/O is in progress for a storage destination sector (or slot) is managed. According to the embodiment, it can be seen that an area (slot or sector) registered in the I/O in-progress management table 515 is in an I/O in-progress state, and an area not registered in the table 515 is I/O completed (for example, I/O is not performed or data is made non-volatile). A registration format may be any format, and may be, for example, registration of a number as illustrated in FIG. 10B, or may be a bitmap (each bit corresponds to a sector) made up of bits each representing whether the I/O in-progress is represented by “1” or “0”.

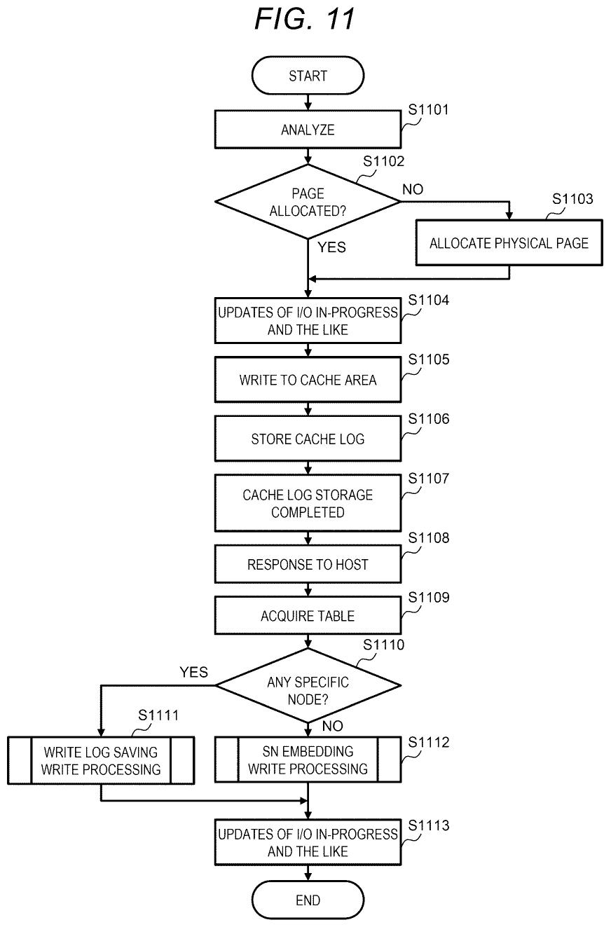

FIG. 11 is a flowchart of the write processing.

The active controller 31A analyzes a write request in which the VVOL 410V is designated (S1101), and determines, for example from the VOL management table 511, whether a physical page is already allocated to a virtual page to which a write destination address (address designated by the write request) belongs (S1102). If a determination result of S1102 is false (S1102: NO), the active controller 31A allocates the physical page to the virtual page to which the write destination address belongs (S1103).

If the determination result of S1102 is true (S1102: YES), or after S1103, the active controller 31A adds information on a slot and a sector corresponding to the write destination address to the I/O in-progress management table 515 as the I/O in-progress, makes the updated table 515 redundant (reflects the updated table 515 in all the storage nodes 102 belonging to the storage controller cluster 30 including the active controller 31A), and saves the updated table 515 in, for example, any non-volatile area (S1104).

The active controller 31A writes the write target data to the cache area 402A (S1105). The active controller 31A refers to, for example, the cache management table 526, creates a cache log, stores the cache log in the cache log buffer 403A, and instructs the data protection control program 32 to add (save) the cache log to the cache log storage area 421A (S1106). In response to this instruction (command), the data protection control program 32 adds the designated cache log to the cache log storage area 421A and returns a completion response to the active controller 31A (S1107). Upon receiving the write request completion response, the active controller 31A returns the completion response to the host 101 (S1108).

The active controller 31A acquires the node management table 513 and the node state management table 514 (S1109). The active controller 31A specifies a plurality of storage nodes 102 belonging to the storage controller cluster 30 having the active controller 31A from the node management table 513, and determines whether there is at least one specific node in the plurality of storage nodes 102 from the node state management table 514 (S1110). The “specific node” in this paragraph is a storage node 102 whose state is neither “normal” nor “unmounted”. If there is at least one specific node, a determination result of S1110 is true. The determination of the S1110 may be a determination as to whether there are a number of specific nodes exceeding redundancy.

If the determination result of S1110 is true (S1110: YES), write log saving write processing is performed (S1111). The write log saving write processing is as described with reference to FIG. 4. That is, in addition to storage of write target data in the physical page (data storage area 422), creation of a write log and addition (saving) of the write log to the write log storage area 423 through the write log buffer 533 are performed.

Meanwhile, if the determination result of S1110 is false (S1110: NO), sequence number embedding write processing is performed (S1112). In the sequence number embedding write processing, since it is not necessary to create a write log and store the write log in the write log storage area 423, it is possible to reduce the number of times of writing to the storage device and improve write performance. As will be described later, even if a power loss occurs during the sequence number embedding write processing, data can be correctly recovered, so that a decrease in data reliability can be prevented.

After S1111 or S1112, the active controller 31A deletes the information on the slot and the sector corresponding to the write destination address from the I/O in-progress management table 515 (that is, manages I/O of the slot and the sector as completion), makes the updated table 515 redundant, and saves the updated table 515 in, for example, one of non-volatile areas (S1113).

To simplify the description, although the guarantee code is not described in illustration of FIG. 11, the guarantee code (for example, 8 Bytes) is generated for each piece of data having a predetermined size (for example, 512 Bytes) in the write target data and stored in the cache log storage area 412, the data storage area 422, and the write log storage area 423.

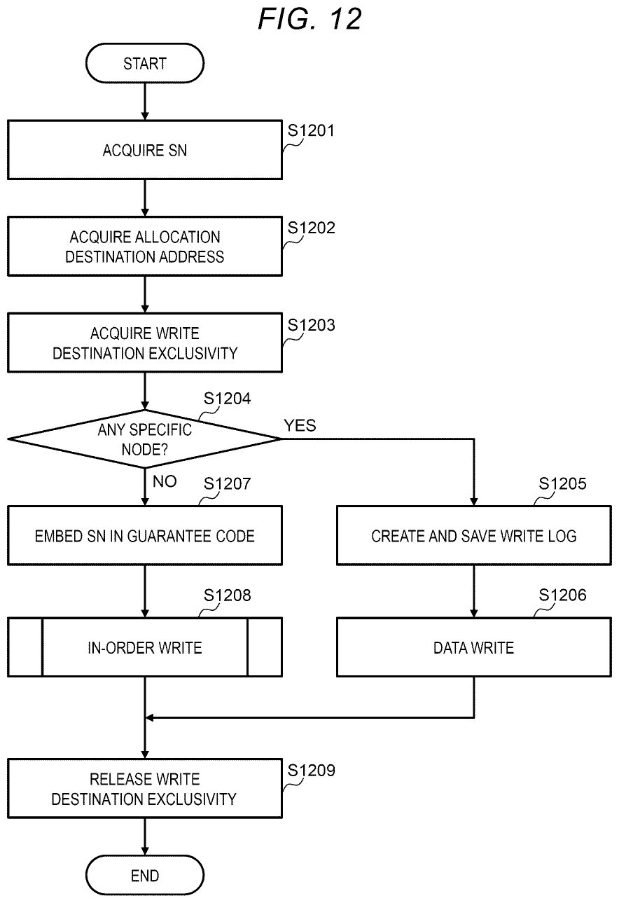

FIG. 12 is a flowchart illustrating details of a portion of the write processing.

In FIG. 12, S1201 to S1203 may be in a part of S1105 to S1109. S1204 may be the same as S1110. S1205 to S1206 may be in S1111. S1207 to S1208 may be in 1112. S1209 may be in S1113.

The active controller 31A acquires the sequence number “0” (S1201). The active controller 31A acquires an allocation destination address (an address of an allocated physical page) (S1202). The data protection control program 32 acquires write destination exclusivity (S1203). “Write destination exclusivity” refers to exclusivity of an allocation destination address acquired by the active controller 31A. The allocation destination address may be an address of a slot or a sector.

If there is a specific node shown in S1110 in FIG. 11 (S1204: YES), the data protection control program 32 creates a write log including data/parity and a guarantee code, and saves (adds) the write log in the write log storage area 423 (S1205). The data protection control program 32 stores the data/parity in the data storage area 422 (S1206). A capacity of the data storage area 422 may be a capacity capable of storing user data, or may be a capacity obtained by subtracting a capacity for storing the parity from a capacity of an area provided by one or more drives 205 on which the data storage area 422 is based. The data/parity and the guarantee code for the data/parity are written to the drive 205.

If there is no specific node (S1204: NO), the data protection control program 32 embeds the sequence number acquired by the active controller 31A in S1201 in the guarantee code for each piece of data/parity (S1207). The data protection control program 32 writes the data and the parity in order (sequentially) to the plurality of storage nodes 102 including the storage node 102 having the program 32 (S1208). For each stripe, the storage node 102 as a storage destination of the user data and the parity is specified from the mapping table 532 by the data protection control program 32.

After S1206 or S1208, the data protection control program 32 releases the write destination exclusivity acquired in S1203 (S1209).

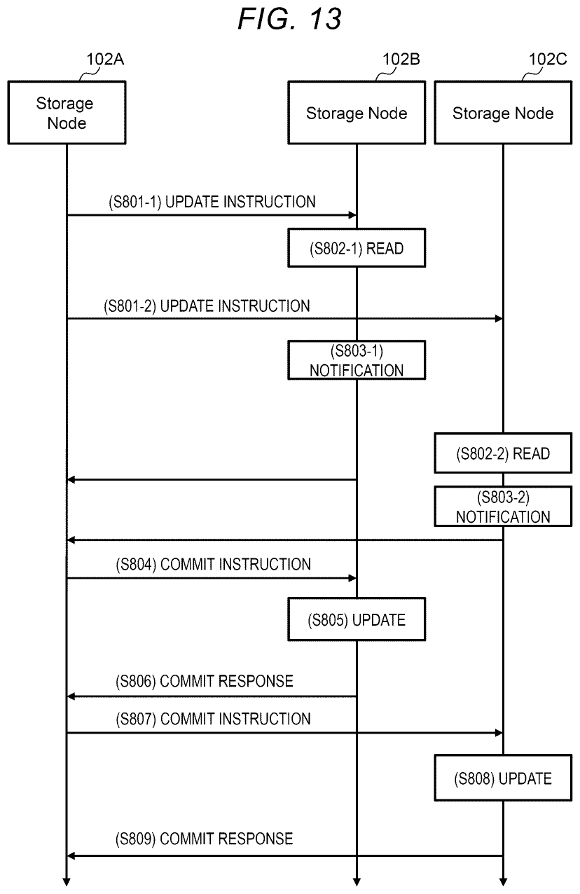

FIG. 13 is a sequence diagram of in-order write.

FIG. 13 is a diagram in which the following example is adopted. That is, the redundant configuration is “4D2P(EC)”. The storage node 102 that receives a write request is the storage node 102A. In a stripe to which a write destination address belongs, a storage destination node of one piece of user data is the storage node 102A, a storage destination node of the first parity is the storage node 102B, and a storage destination node of the second parity is the storage node 102C. In illustration of FIG. 13, for clarification of the illustration, “x” is added to an end of a reference sign of an element in a storage node 102x (x=A, B, or C). In illustration of FIG. 13 and subsequent drawings, “A” of the “storage controller 31A” does not mean an active state but means an element in the storage node 102A.

For the in-order write, a so-called two-phase commit is adopted. In a first phase, transmission of an update instruction and processing in response to the update instruction may be performed in order (sequentially), but are performed in parallel in the embodiment. However, in a second phase, transmission of a commit instruction and return of a commit response are performed in order (sequentially).

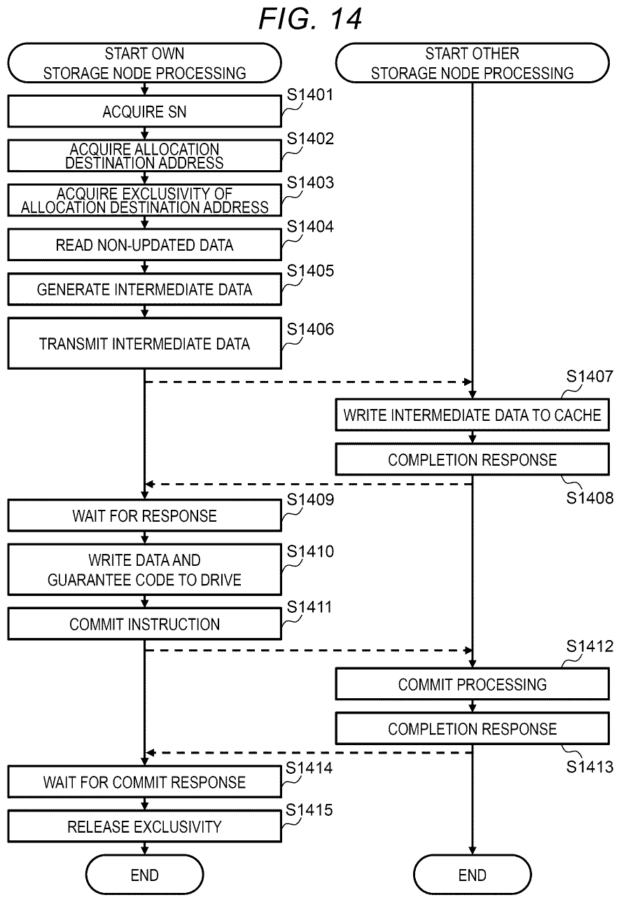

That is, the data protection control program 32A (or the storage controller 31A) transmits an update instruction for a first parity and a guarantee code thereof to the storage node 102B in parallel (S801-1), and transmits an update instruction for a second parity and a guarantee code thereof to the storage node 102C (S801-2). Each update instruction may include the sequence number “0” acquired in S1201 and intermediate data (data used to generate parity) described later with reference to FIG. 14. In parallel, in response to the update instruction, the data protection control program 32B (and/or the storage controller 31B) may read old first parity (non-updated first parity) and a guarantee code thereof from a drive 205B to a cache area 402B (S802-1) and notify the data protection control program 32A of commit stand-by (S803-1), and in response to the update instruction, the data protection control program 32C (and/or the storage controller 31B) may read old second parity (non-updated second parity) and a guarantee code thereof from a drive 205C to a cache area 402C (S802-2) and notify the data protection control program 32A of commit stand-by (S803-2). Between S802-1 and S803-1, synchronization (sharing) with an update of an I/O in-progress management table 515B may be performed. Between S802-2 and S803-2, synchronization with an update of an I/O in-progress management table 515C may be performed.

When the storage node 102A receives the commit stand-by notification from the storage nodes 102B and 102C, next processing is performed in order.

That is, the data protection control program 32A (or the storage controller 31A) transmits a commit instruction to the storage node 102B (S804). In response to the commit instruction, the data protection control program 32B (and/or the storage controller 31B) updates the old first parity in the cache area 402B according to the update instruction transmitted in S801-1, updates the sequence number from “0” to “1”, embeds the sequence number “1” in a guarantee code of new first parity (updated first parity), stores the new first parity and the guarantee code thereof in the drive 205B (S805), and returns a commit response to the storage node 102A (S806).

When receiving the commit response, the data protection control program 32A (or the storage controller 31A) transmits a commit instruction to the storage node 102C (S807). In response to the commit instruction, the data protection control program 32C (and/or the storage controller 31C) updates the non-updated second parity in the cache area 402C according to the update instruction transmitted in S801-2, updates the sequence number from “0” to “1”, embeds the sequence number “1” in a guarantee code of new second parity (updated second parity), stores the new second parity and the guarantee code thereof in the drive 205C (S808), and returns a commit response to the storage node 102A (S809).

FIG. 14 is a flowchart of processing between storage nodes in the sequence number embedding write processing.

To clarify and simplify the description, it is assumed that the “own storage node” in FIG. 14 is the storage node 102A in FIG. 13, and the “other storage node” in FIG. 14 is the storage node 102B in FIG. 13. FIG. 14 is a diagram representing FIGS. 12 and 13 from another viewpoint. In the description of FIG. 14, for clarification of the description, “x” is added to an end of a reference sign of an element in the storage node 102x (x=A or B).

The storage controller 31A acquires the sequence number “0” (S1401), acquires an allocation destination address (S1402), and the data protection control program 32A acquires exclusivity of the allocation destination address (S1403). S1401 to S1403 are the same as S1201 to S1203.

The storage controller 31A reads old data (non-updated user data) of new data (updated user data) according to a write request from the drive 205A to the cache area 402A (S1404). The storage controller 31A uses the new data and the old data to generate intermediate data for parity generation (S1405). The storage controller 31A (or the data protection control program 32A) transmits an update instruction including the sequence number “0” and the intermediate data generated in S1405 to the storage node 102B (S1406). S1406 is in S801-1 in FIG. 13.

In response to the update instruction from the storage node 102A, the storage controller 31B (and/or the data protection control program 32B) reads the old first parity and the guarantee code thereof to the cache area 402B, writes the intermediate data in the update instruction to the cache area 402B (S1407), and returns a completion response (notification) to the storage node 102A (S1408). S1407 and S1408 are the same as S802-1 and S803-1. At this stage, the new first parity may be generated using the intermediate data and the read old first parity and stored in the cache area 402B. S1407 and S1408 are in S802-1 and S803-1 in FIG. 13.

The storage controller 31A (or the data protection control program 32A) waits for a response to the update instruction (S1409). When the completion response is received, the storage controller 31A (and/or the data protection control program 32A) updates the sequence number from “0” to “1” for the new data according to the write request, embeds the new data and the sequence number “1” for the new data in the guarantee code, and writes the new data and the guarantee code thereof to the drive 205A (S1410).

Next, the storage controller 31A (or the data protection control program 32A) transmits a commit instruction to the storage node 102B (S1411). S1411 is in S804 in FIG. 13.

The storage controller 31B (and/or the data protection control program 32B) performs commit processing in response to the commit instruction (S1412). That is, the storage controller 31B (and/or the data protection control program 32B) generates new first parity using the intermediate data and the old first parity on the cache area 402B, updates the sequence number from “0” to “1”, embeds the sequence number “1” in a guarantee code of the new first parity, and stores the new first parity and the guarantee code thereof in the drive 205B. When the commit processing is completed, the storage controller 31B (or the data protection control program 32B) returns a completion response to the storage node 102A (S1413). S1412 is in S805 in FIG. 13. S1413 is in S806 in FIG. 13.

The storage controller 31A (or the data protection control program 32A) waits for a response to the commit instruction (S1414). When the completion response is received, the data protection control program 32A releases the exclusivity (exclusivity of the allocation destination address) acquired in S1403 (S1415).

The series of processing illustrated in FIG. 14 is in S1112 in FIG. 11. After the processing illustrated in FIG. 14, S1113 in FIG. 11 is performed.

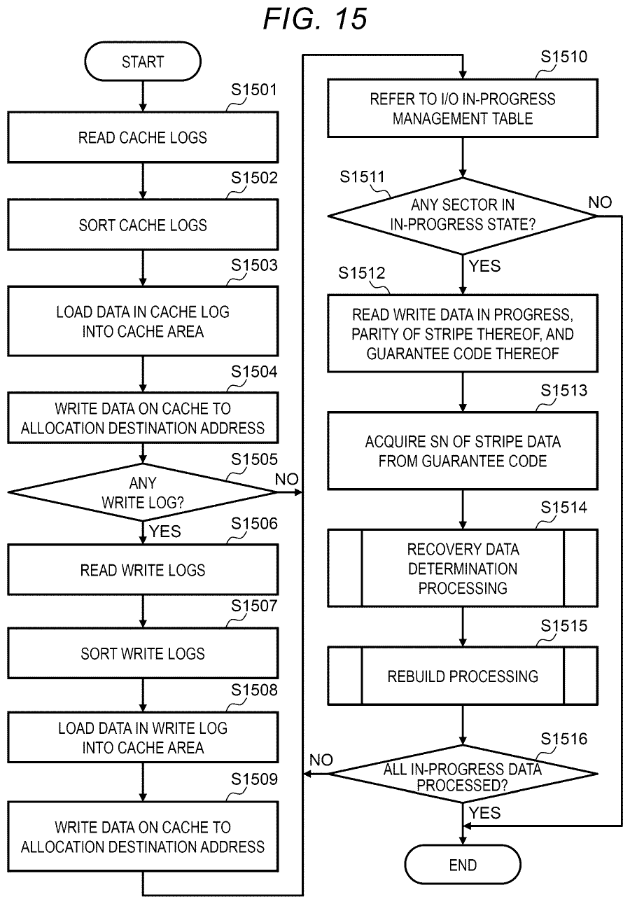

FIG. 15 is a flowchart of power interruption recovery processing.

The power interruption recovery processing is performed when power of the storage system 100 is lost and power is turned on. Power of all the storage nodes 102 in the storage system 100 may be the same (for example, the storage system 100 may be a single availability zone), but the power may be different between the storage nodes 102 (for example, the storage system 100 may be a multi-availability zone). Hereinafter, in order to simplify the description, it is assumed that the storage node 102A is recovered from the power loss (power interruption). Hereinafter, in order to simplify the description, it is assumed that all the processing is performed by the storage controller 31A, but at least a part of the processing may be performed by the data protection control program 32A instead of the storage controller 31A or in cooperation with the storage controller 31A.

The storage controller 31A reads cache logs from the cache log storage area 421A (S1501). Next, the storage controller 31A sorts the cache logs read in S1501 in order of cache log sequence numbers (S1501). Here, the “cache log sequence number” is a sequence number (for example, a serial number) of the cache log, corresponds to an order in which data is written to a cache, and is information in the cache log.

Subsequently, the storage controller 31A loads the data in the cache log into the cache area 402A in the sorted order (S1503). Accordingly, the data is recovered in the cache area 402A. A load destination may be an area of an address specified from the cache log.

The storage controller 31A writes the data loaded in the cache area 402 to an allocation destination address in the drive 205A (S1504). The “allocation destination address” may be specified from a cache log including the loaded data.

Subsequently, the storage controller 31A determines whether there is a write log of the data written in S1504 (S1505). The write log includes, for example, information indicating a write log sequence number which is a sequence number (for example, a serial number) of the write log, a write destination address of the data, and a size of the data. The determination of S1505 may be, for example, a determination as to whether a write log including information indicating a write destination address matching the allocation destination address specified in S1504 is present in the write log storage area 423A. The “write log sequence number” may correspond to an order in which data is written to the drive 205A.

If a determination result of S1505 is true (S1505: YES), the storage controller 31A reads write logs from the write log storage area 423A (S1506). Subsequently, the storage controller 31A sorts the read write logs in order of write log sequence number (S1507). Subsequently, the storage controller 31A extracts data from the write log in the sorted order, and loads the extracted data into the cache area 402A (S1508). The storage controller 31A writes the data on the cache area 402 (data extracted from the write log) to an allocation destination address of the drive 205A (S1509). The “allocation destination address” (write destination address) may be specified from a write log including the loaded data.

If the determination result of S1505 is false (S1505: NO), S1506 to S1509 are skipped. After S1509 or if the determination result of S1505 is false, the storage controller 31A refers to the I/O in-progress management table 515A (S1510), and determines whether there is a sector in the in-progress state (S1511). The determination of S1511 corresponds to a determination as to whether there is at least one entry in the I/O in-progress management table 515A for which processing after S1510 is still performed.

If the determination result of S1511 is true (S1511: YES), the storage controller 31A reads the write data in progress corresponding to the one entry in the I/O in-progress management table 515A, parity of a stripe including the write data, and a guarantee code of each of the write data and the parity (S1512). Subsequently, the storage controller 31A acquires a sequence number from each guarantee code read in S1512 (S1513). The storage controller 31A performs recovery data determination processing using the acquired sequence number (S1514), and then performs rebuild processing (S1515).

S1510 and subsequent processing are performed for all entries in the I/O in-progress management table 515A (S1516: NO). If the processing after S1510 is performed for all the entries in the I/O in-progress management table 515A (S1516: YES), or if the determination result of S1511 is false (S1511: NO), the power interruption recovery processing ends. The processing may return to S1510 after S1515 without S1516.

According to the power interruption recovery processing described above, in S1501 to S1504, it is possible to store, in the drive 205A, data that is loaded in the cache area 402A but is not stored in the drive 205A due to a power loss. In S1506 to S1509, the data in which the write log is stored in the write log storage area 423A in S1111 in FIG. 11 but may not be stored in the data storage area 422A due to the power loss can be stored in the drive 205A on which the data storage area 422A is based. In S1510 to S1516, data that is not stored in the drive 205A due to a power loss during the I/O in-progress can be recovered and stored in the drive 205A.

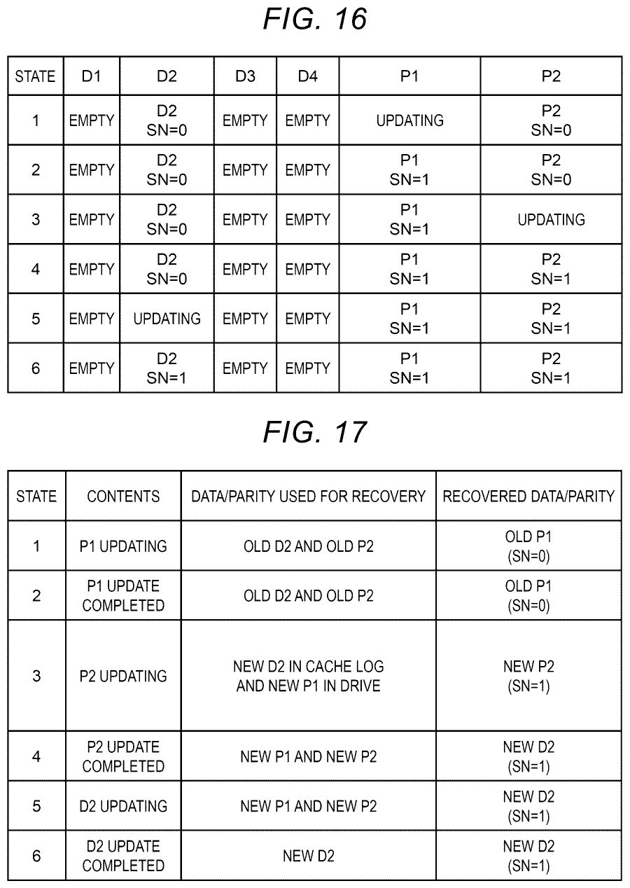

FIG. 16 illustrates a list of write states in the sequence number embedding write processing.

A case where the redundant configuration is “4D2P(EC)” is taken as an example. FIG. 16 illustrates an example in which the storage node 102 that receives the write request is the storage node 102 that stores data D2 in a write destination stripe, and only the data D2 among data D1 to D4 is an update target.

As described above, in the sequence number embedding write processing, the two-phase commit is adopted, and the in-order write is performed. Specifically, the commit instruction and the commit response are exchanged in order (sequentially). Therefore, one of the write states 1 to 6 as illustrated in FIG. 16 occurs. For example, the write state sequentially transitions from 1 to 6. Therefore, even if a power loss occurs during the in-order write, it is possible to uniquely specify the write state (that is, which of non-updated, updating, and updated for each address) when the power loss occurs.

In FIG. 16, “SN=0” means that the sequence number is “0”, that is, non-updated. “SN=1” means that the sequence number is “1”, that is, updated. “Updating” is a state between non-updated and updated, specifically, a state in which a write destination address is registered in the I/O in-progress management table 515.

Even when the sequence number “1” is embedded in the guarantee code of the data/parity stored in the drive 205, if an address according to the write request is an address of an area in which the data/parity is stored and is an address that is not registered in the I/O in-progress management table 515, a write state for the address is “non-updated” because the sequence number “0” is acquired. If the address is registered in the I/O in-progress management table 515, the write state for the address is “updating” until the address is deleted from the I/O in-progress management table 515.

FIG. 17 is a list of correspondence relationships between the write states and recovery details.

FIG. 17 is a diagram corresponding to FIG. 16. That is, the write states 1 to 6 shown in FIG. 17 correspond to the write states 1 to 6 shown in FIG. 16. As described above, since the write state when the power loss occurs can be specified, recovery corresponding to the specified write state may be performed. FIG. 17 illustrates the following. In the following description, the data D2 is simply referred to as “D2”, first parity P1 is simply referred to as “P1”, and second parity is simply referred to as “P2”. For convenience, a storage destination node 102 of the D2 is referred to as “node D2”, a storage destination node of the P1 is referred to as “node P1”, and a storage destination node of the P2 is referred to as “node P2”. In the example illustrated in FIG. 17, in recovery of the data/parity, any one of the nodes cooperates with a storage destination node of the data/parity to be recovered or another node, so that the data/parity to be used for the recovery is acquired from the storage destination node of each of a plurality of pieces of data/parity to be used for the recovery, and the data/parity is recovered using the plurality of pieces of data/parity that are acquired. In FIG. 17, although D1, D3, and D4 among the data D1 to D4 are not indicated in a column of “data/parity used for recovery”, each of the D1, D3, and D4 is not an update target, and thus is new data and old data. Storage destination nodes of the D1, D3, and D4 may be referred to as “node D1”, “node D3”, and “node D4”.

When the power is turned on after the power loss occurs in the write state 1 or the write state 2, the data recovered through the S1514 and the S1515 illustrated in FIG. 15 is old P1. In addition to the D1, D3, and D4 in the nodes D1, D3, and D4, old D2 and old P2 are used to recover the old P1. This is because generations thereof are “old” (sequence number “0”). Specifically, the old P1 is recovered using the old D2 in the node D2 and the old P2 in the node P2. In other words, according to the write state 2, it is expected that new P1 can be obtained from the node P1, but since generations of D2 and P2 are different from a generation of the P1, the old P1 is recovered in order to unify the generations.

When the power is turned on after the power loss occurs in the write state 3, the data recovered through S1514 and S1515 illustrated in FIG. 15 is new P2. In addition to the D1, D3, and D4, new D2 in the cache log in the node D2 and the new P1 in the drive 205 in the node P1 are used to recover the new P2. The D2 is old, while the P1 is new, so the generations do not match, and the data/parity with the unified generation cannot be recovered using only the data/parity in the drive. Therefore, the new P2 is recovered using the new D2 in the cache log and the new P1 in the drive.

When the power is turned on after the power loss occurs in the write state 4 or the write state 5, the data recovered through the S1514 and the S1515 illustrated in FIG. 15 is the new D2. In addition to at least two of the D1, D3, and D4, at least one of the new P1 in the node P1 and the new P2 in the node P2 is used to recover the new D2. This is because the generation of both the P1 and P2 is “new” (sequence number “1”).

Even when the power is turned on after the power loss occurs in the write state 6, the data recovered through S1514 and S1515 illustrated in FIG. 15 is the new data D2. The new D2 is used to recover the new D2. This is because generations of all data/parity are “new”.

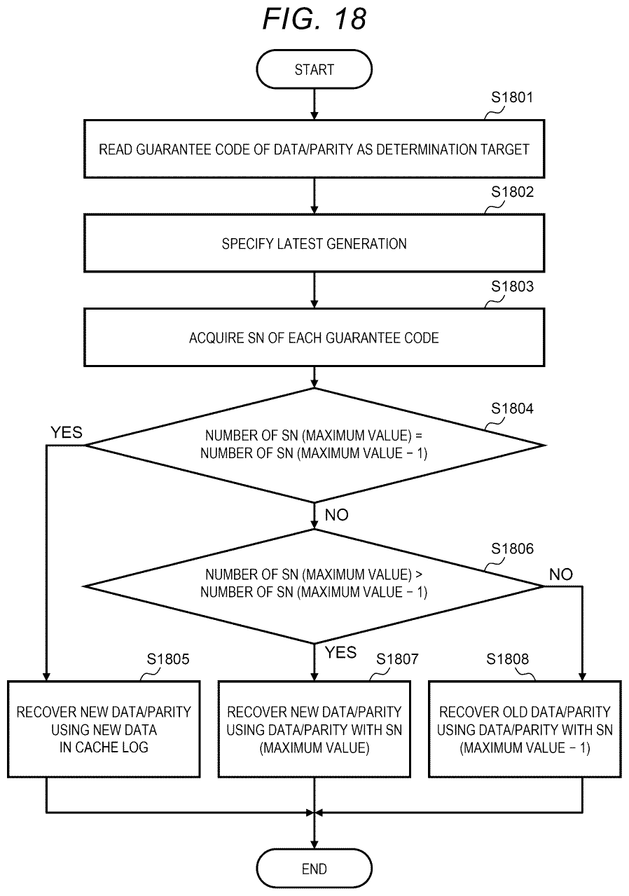

FIG. 18 is a flowchart of the recovery data determination processing (S1514 in FIG. 15).

The storage controller 31 reads guarantee codes of all data/parity as a determination target (S1801). The “data/parity as determination target” here is the D2, P1, and P2 in the examples of FIGS. 16 and 17.

The storage controller 31 specifies the latest generation based on sequence numbers in the guarantee codes of all the data/parity as a determination target (S1802). The “latest generation” in the embodiment is either “old” or “new”.

The storage controller 31 acquires the sequence number from the guarantee code for each of all determination target data/parity (S1803).

The storage controller 31 determines whether the number of sequence numbers (maximum value) is the same as the number of sequence numbers (maximum value−1) (S1804). In the embodiment, the “maximum value” of the “sequence numbers (maximum value)” is “1”, and thus the “maximum value−1” is “0”.

If the determination result of S1804 is true (S1804: YES), it is not possible to determine whether the sequence number in the guarantee code is new or old. That is, in drives between nodes, the number of old data/parity and the number of pieces of new data/parity are the same, and it is not possible to determine which generation is to be unified. This corresponds to, for example, the write state 3. Therefore, the storage controller 31 recovers target new data/parity using the new data in the cache log (S1805). It is apparent from FIGS. 11 and 14 that there is “new data” in the cache log. That is, the cache log of the new data is created and made non-volatile (S1105 to S1107) before the sequence number of the parity becomes “1” (before S1412).

If the determination result of S1804 is false (S1804: NO), the storage controller 31 determines whether the number of sequence numbers (maximum value) is larger than the number of sequence numbers (maximum value−1) (S1806).

A determination result of S1806 being true (S1806: YES) corresponds to, for example, the write states 4 to 6. Therefore, in this case, the storage controller 31 recovers the target new data using the new data/parity corresponding to the sequence number (maximum value) (S1807).

Meanwhile, the determination result of S1806 being false (S1806: NO) corresponds to, for example, the write states 1 and 2. Therefore, in this case, the storage controller 31 recovers the target old data using the old data/parity corresponding to the sequence number (maximum value−1) (S1808).

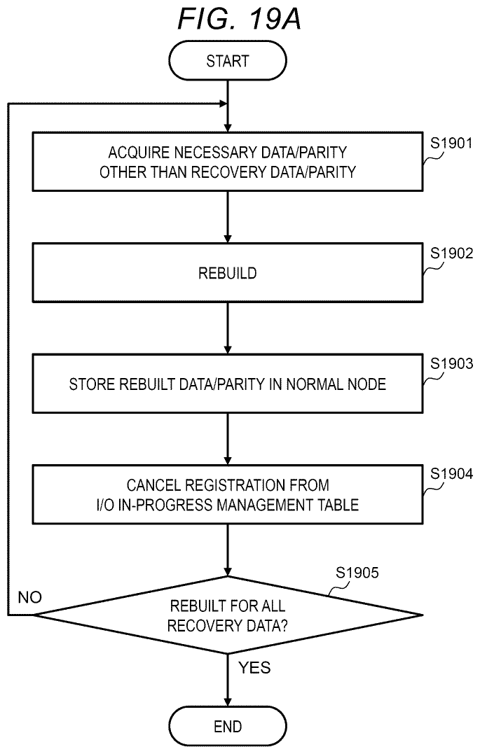

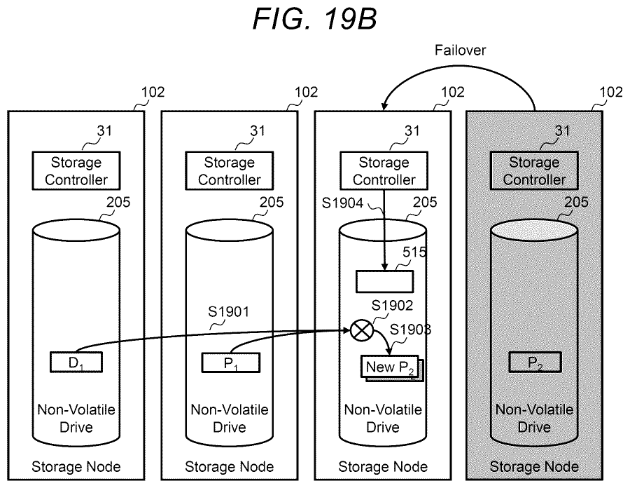

FIG. 19A is a flowchart of the rebuild processing (S1515 in FIG. 15). FIG. 19B is a schematic diagram of the rebuild processing.

The rebuild processing is processing for rebuilding, when there is a “specific node” (for example, a node in which some failure occurs) in the illustration of FIG. 11, data in the specific node and writing rebuilt data back to any normal node.

The storage controller 31 acquires, from the normal node, data/parity other than the recovered data/parity among the data/parity necessary for rebuilding the data/parity in the specific node (S1901). The “normal node” is the storage node 102 whose node state is “normal”.

The storage controller 31 rebuilds the data/parity in the specific node using the data/parity acquired in S1901 and the recovered data/parity (S1902). The storage controller 31 stores the rebuilt data/parity in any normal node (S1903). The storage controller 31 deletes registration (entry) corresponding to the recovery data/parity used for the rebuild from the I/O in-progress management table 515 (S1904).

If S1901 to S1903 are performed for all the recovery data/parity (S1905: YES), the rebuild processing ends.

Although one embodiment has been described above, this embodiment is an example for describing the invention, and the scope of the invention is not limited to this embodiment. The invention can be implemented in various other forms.

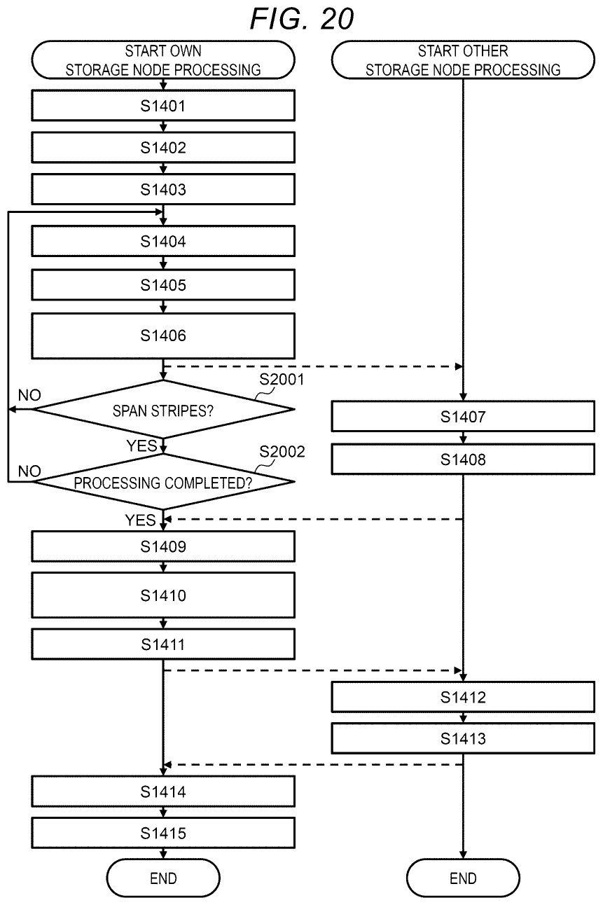

For example, a write destination range according to a write request (for example, a range according to a combination of a write destination address and a data length) may span stripes, such as from beginning or middle of one stripe to a middle of next or subsequent stripe, or from a middle of one stripe to a middle or end of the next or subsequent stripe. Therefore, for example, as illustrated in FIG. 20, after S1406, the storage controller 31A may determine whether the write destination range spans stripes (S2001). If a determination result of S2001 is true (S2001: YES), when S1404 to S1406 ends for each stripe belonging to the write destination range (S2002: YES), the processing proceeds to S1409.

For example, a drive unit is connected to an outside of the storage node 102, and the drive unit may be an example of a non-volatile storage device, and may include one or more drives 205. A storage area 405 may be provided in the storage node 102 based on one or more drives 205 in the drive unit.

The guarantee code may not necessarily be added to each piece of data/parity that is written. In this case, data (for example, metadata) such as a sequence number may be simply associated with each piece of data/parity. However, since a guarantee code used to verify consistency of data/parity is generally added to each piece of data/parity, it is efficient to include a sequence number in such a guarantee code. For example, a field in the guarantee code has a field in which data indicating a storage destination drive of the data/parity to which the guarantee code is added is described, but a size of the field may be reduced depending on the number of drives 205 in the storage node 102 (or associated outside the storage node 102), and the sequence number may be described in the reduced field.

The above description can be summarized as follows, for example. The following summary may include a supplementary description of the above description and a description of modifications.

A storage system (for example, a storage system 100) includes a plurality of storage nodes (for example, storage nodes 102) each having a non-volatile storage device (for example, one or more non-volatile drives 205) outside or inside and each having a memory (for example, memory 202). Each storage node may include a controller (for example, storage controller 31). Two or more controllers of two or more different storage nodes may constitute a cluster (for example, storage controller cluster 30). In the cluster, one controller may be active and another controller may be stand-by. Each of the plurality of storage nodes includes a data storage area (for example, data storage area 422) based on a storage area (for example, storage area 450) provided by the non-volatile storage device. In the write processing, the controllers of two or more different storage nodes (for example, one active controller and one or more stand-by controllers) write two or more pieces of updated data to two or more data storage areas of the two or more storage nodes. Specifically, for example, as in the processing according to the in-order write (S1208) described above, the controllers of the two or more storage nodes may sequentially write the two or more pieces of updated data to the two or more data storage areas (that is, write another piece of data after writing of one piece of data is completed). The two or more pieces of updated data form a stripe. The two or more pieces of updated data include one or more pieces of user data which are one or more pieces of data constituting data related to a write request, and one or more pieces of redundant data of the one or more pieces of data. In the write processing in which two or more pieces of updated data are written to two or more data storage areas, a controller of one storage node (for example, the storage node 102A that receives a write request) assigns a sequence number which is a number associated with each of the two or more pieces of data and updated according to a state related to writing of the data to the data storage area. When power is lost (for example, power is lost in the write processing) and power is turned on again in relation to the two or more storage nodes, the controller of at least one storage node of the two or more storage nodes specifies data as an update target when the power is lost from the two or more pieces of data based on the sequence number of each of the two or more pieces of data of the stripe, and determines which of non-updated data and updated data is a recovery target for the data as an update target.

Each storage node does not need to include a backup power supply such as a battery, but in this case, if power loss occurs during a data update to the non-volatile storage device, data corruption may occur in the data as an update target. Therefore, for example, as illustrated in FIG. 4, it can be expected that one storage node generates a write log, records the generated write log in a write log storage area (for example, write log storage area 423) in a storage area provided by the non-volatile storage device, and recovers data from the write log after power is turned on again, thereby protecting the data from data corruption due to the power loss.

Meanwhile, since the write log is generated and stored, a processing amount of the write processing related to the write request increases, and write performance decreases.

Therefore, as described above, a sequence number is assigned to each of two or more pieces of data forming the stripe. At the time of assigning the sequence number, the sequence number is a number which is the same for the user data and the redundant data in the stripe. The stripe includes a plurality of user data (data obtained by dividing the write data received from the host) related to the same write request and redundant data (data generated based on the plurality of user data). Therefore, even if a power loss occurs in the middle of the write processing, it is possible to find the stripe in the middle of the update (before a part of the data is written to the drive) or to determine whether to recover the non-updated data or updated data by referring to the sequence number associated with the data in the stripe. Thus, since data as a recovery target can be appropriately determined, it is expected to achieve high performance by reducing the write log while maintaining high reliability.

Specifically, when the number of pieces of data associated with the sequence number (for example, the sequence number (maximum value−1)) corresponding to non-updated data is larger than the number of pieces of data associated with the sequence number (for example, the sequence number (maximum value)) corresponding to updated data, the at least one storage node may determine to recover the updated data for the data as an update target. Meanwhile, when the number of pieces of data associated with the sequence number corresponding to non-updated data is smaller than the number of pieces of data associated with the sequence number corresponding to updated data, the at least one storage node may determine to recover the non-updated data for the data as an update target. Thus, in the redundant configuration, the data can be appropriately recovered so that a state is unified to either before the update or after the update. For each piece of data in the stripe, the sequence number associated with the updated data may be a number obtained by incrementing the sequence number associated with the non-updated data.

There may be a cache log storage area (for example, cache log storage area 421) based on the storage area provided by the non-volatile storage device. One storage node may write the data related to the write request in the cache area, store the cache log including the data in the cache log storage area, return a response to the write request, and then assign a sequence number associated with two or more pieces of data including the data related to the write request and forming the stripe. When the number of pieces of data associated with the sequence number corresponding to the updated data is the same as the number of pieces of data associated with the sequence number corresponding to the non-updated data, the at least one storage node may determine to recover the updated data for the data as an update target using the data in the cache log. Accordingly, when recovering from the power loss in the state where either the updated state and the non-updated state may be unified, the updated state can be unified using the data in the cache log.

For example, there may be a write log storage area (for example, write log storage area 423) based on the storage area provided by the non-volatile storage device. One storage node may determine whether a difference between the number of storage nodes, of the two or more storage nodes, in a state in which data cannot be written (for example, a state other than a normal state or a state similar thereto) and redundancy of a redundant configuration provided by the two or more storage nodes is equal to or less than a predetermined value (for example, whether data recovery can be disabled if the number of storage nodes in the state further increases because the number of storage nodes in the state matches the redundancy). If a determination result is false, the one storage node may assign a sequence number. Meanwhile, if the determination result is true, the one storage node may generate a write log including data to be written to the data storage area and write the write log to the write log storage area. For example, if a power loss occurs when there are a number of failed nodes (failed storage nodes) that matches the redundancy, data may not be recovered, but reliability and performance can be appropriately maintained by switching a mode (sequence number association without write log generation or write log generation without sequence number association) according to the determination result.

The redundant data may be mirrored data or parity. By embedding the sequence number in the guarantee code of each of the data and the redundant data, a consumed storage capacity of the data storage area can be reduced.

The storage node 102 described above has the I/O in-progress management table 515. For example, when the storage node 102 (own node) that receives a write request updates the drive 205 in the own node that is a write destination, an update destination address is managed as being in progress. When the own node issues a parity update instruction to another node (the other storage node 102), the other node that receives the update instruction registers a drive address in which parity as an update target is stored in an I/O in-progress management table of the other node as in progress. The I/O in-progress management table 515 manages the drive 205 of each node, the corresponding LBA, and a data write status (in-progress status) to the drive 205. The LBA of a VOL viewed from the host 101 can be specified from the mapping table 532, and a drive and address of each node are uniquely determined. Therefore, an address relationship can be determined at the time of recovery by managing the I/O in-progress management table 515 in each node.

What is claimed is:

1. A storage system comprising:
a plurality of storage nodes each including a controller and a memory; and
a non-volatile storage device provided inside or outside a corresponding one of the storage nodes, wherein
each of the plurality of storage nodes has a data storage area based on a storage area of the non-volatile storage device,
in write processing, controllers of two or more different storage nodes write two or more pieces of updated data to two or more data storage areas of the two or more storage nodes,
the two or more pieces of updated data form a stripe, and the two or more pieces of updated data include
one or more pieces of user data which are one or more pieces of data constituting data related to a write request, and
one or more pieces of redundant data of the one or more pieces of data, and
in the write processing in which the two or more pieces of updated data are written to the two or more data storage areas, the controller assigns a sequence number which is a number associated with each of the two or more pieces of data and updated according to a state related to writing of the data to the data storage area, and when power is lost and power is turned on again in relation to the two or more storage nodes, a controller of at least one storage node of the two or more storage nodes specifies data as an update target when the power is lost from the two or more pieces of data based on the sequence number of each of the two or more pieces of data of the stripe, and determines which of non-updated data and updated data is a recovery target for the data as an update target.

2. The storage system according to claim 1, wherein
the controller of the at least one storage node
determines to recover the updated data for the data as an update target when the number of pieces of data associated with the sequence number corresponding to the non-updated data is larger than the number of pieces of data associated with the sequence number corresponding to the updated data, and
determines to recover the non-updated data for the data as an update target when the number of pieces of data associated with the sequence number corresponding to the non-updated data is smaller than the number of pieces of data associated with the sequence number corresponding to the updated data.

3. The storage system according to claim 2, wherein
for each of the two or more pieces of data in the stripe, the sequence number associated with the updated data is a number which is an increment of the sequence number associated with the non-updated data.

4. The storage system according to claim 1, wherein
the memory includes a cache area,
each of the plurality of storage nodes includes a cache log storage area based on the storage area of the non-volatile storage device,
a controller of the one storage node writes data related to the write request to the cache area, stores a cache log including the data in the cache log storage area, then returns a response to the write request, and thereafter assigns the sequence number associated with the two or more pieces of data including the data related to the write request and forming the stripe, and
when the number of pieces of data associated with the sequence number corresponding to the updated data is equal to the number of pieces of data associated with the sequence number corresponding to the non-updated data, the controller of the at least one storage node determines to recover the updated data for the data as an update target using the data in the cache log.

5. The storage system according to claim 1, wherein
the controller of the one storage node
determines whether a difference between the number of storage nodes, of the two or more storage nodes, in a state in which data cannot be written and redundancy of a redundant configuration provided by the two or more storage nodes is equal to or less than a predetermined value, and
if a determination result is false, assigns the sequence number.

6. The storage system according to claim 5, wherein
each of the plurality of storage nodes includes a write log storage area based on the storage area of the non-volatile storage device, and
if the determination result is true, the controller of the one storage node generates a write log including data to be written to the data storage area and writes the write log to the write log storage area.

7. The storage system according to claim 1, wherein
a guarantee code used to verify consistency of the data is added to each of the two or more pieces of data, and
the sequence number of the data is embedded in the guarantee code.

8. A storage control method, in which in write processing in which two or more pieces of updated data forming a stripe are written to two or more data storage areas of two or more different storage nodes among a plurality of storage nodes each having a data storage area based on a storage area of a non-volatile storage device and each including a memory, one storage node assigns a sequence number which is a number associated with each of the two or more pieces of data and updated according to a state related to writing of the updated data to the data storage area, and the two or more pieces of updated data include one or more pieces of user data which are one or more pieces of data constituting data related to a write request and one or more pieces of redundant data of the one or more pieces of data, the storage control method comprising:
when power is lost and power is turned on again in relation to the two or more storage nodes, by at least one storage node of the two or more storage nodes, specifying data as an update target when the power is lost from the two or more pieces of data based on the sequence number of each of the two or more pieces of data of the stripe, and determining which of non-updated data and updated data is a recovery target for the data as an update target.
